(19) United States
(12) Patent Application Publication
(10) Pub. No.: US 2010/0057765 A1
(43) Pub. Date: Mar. 4, 2010

(54) EMAIL ATTACHMENT STORAGE METHOD AND SYSTEM

(76) Inventors: Jean-Claude Dispensa, Saint-Jeannet (FR); Dominique Rossi-Chevrel, Batiment (FR)

Correspondence Address: SCHMEISER, OLSEN & WATTS, 22 CENTURY HILL DRIVE, SUITE 302, LATHAM, NY, 12110, US

(21) Appl. No.: 12/202,466

(22) Filed: Sep. 2, 2008

(30) Foreign Application Priority Data
Aug. 28, 2008 (EP) EP08305505.3

(51) Int. Cl. G06F 17/30; G06F 15/16

(52) U.S. Cl. 707/102; 709/206; 707/10; 707/E17.044; 707/E17.01; 707/E17.032

(57) ABSTRACT

An email method and system. The method includes receiving by a computing system, an email addressed to a recipient. The computing system retrieves from an internal table of files, a file link and an ID associated with an attached file attached to the email. The file link points to a location within the computing system for the attached file. The computing system removed the attached file from the email. The computing system generates a copy of the email and places the file link and the ID in the copy of the email. The computing system retrieves and stores identification data for the recipient. The computing system determines a total file size for all files being accessed by the recipient. The computing system determines if the file total size exceeds a file size threshold. The computing system transmits the copy of the email comprising the file link and the ID.

### FIELD OF THE INVENTION

The present invention relates to a method and associated system for removing and storing attached files from emails.

### BACKGROUND OF THE INVENTION

Minimizing storage space for files typically comprises an inaccurate process with little flexibility. Accordingly, there exists a need in the art to overcome at least some of the deficiencies and limitations described herein above.

### SUMMARY OF THE INVENTION

The present invention provides a method comprising:

receiving, by a computing system, an email addressed to a first recipient, wherein said first recipient is a main recipient for said email;

determining, by said computing system, that said email comprises an attached file;

retrieving, by said computing system from an internal table of files, a file link and an ID associated with said attached file, wherein said file link points to a location within said computing system for said attached file;

removing, by said computing system, said attached file from said email;

after said removing, generating by said computing system, a first copy of said email;

placing, by said computing system in said first copy of said email, said file link and said ID;

retrieving, by said computing system from said email, first identification data associated with said first recipient;

storing, by said computing system in a first portion of an internal table of recipients, said first identification data, wherein said first portion of said internal table of recipients is reserved for said first recipient;

determining, by said computing system, a number of users for said attached file;

storing, by said computing system in said internal table of files, said first link and a file size for said attached file;

determining, by said computing system, a first total size for all files being accessed by said first recipient, wherein said determining said first total size comprises adding said file size to all additional file sizes for additional files being accessed by said first recipient;

determining, by said computing system, if said first total size exceeds a first file size threshold; and

transmitting, by said computing system to said first recipient, said first copy of said email comprising said file link and said ID.

The present invention provides a computing system comprising a processor coupled to a computer-readable memory unit, said memory unit comprising instructions that when executed by the processor implements an email method, said method comprising:

receiving, by a computing system, an email addressed to a first recipient, wherein said first recipient is a main recipient for said email;

determining, by said computing system, that said email comprises an attached file;

retrieving, by said computing system from an internal table of files, a file link and an ID associated with said attached file, wherein said file link points to a location within said computing system for said attached file;

removing, by said computing system, said attached file from said email;

after said removing, generating by said computing system, a first copy of said email;

placing, by said computing system in said first copy of said email, said file link and said ID;

retrieving, by said computing system from said email, first identification data associated with said first recipient;

storing, by said computing system in a first portion of an internal table of recipients, said first identification data, wherein said first portion of said internal table of recipients is reserved for said first recipient;

determining, by said computing system, a number of users for said attached file;

storing, by said computing system in said internal table of files, said first link and a file size for said attached file;

determining, by said computing system, a first total size for all files being accessed by said first recipient, wherein said determining said first total size comprises adding said file size to all additional file sizes for additional files being accessed by said first recipient;

determining, by said computing system, if said first total size exceeds a first file size threshold; and

transmitting, by said computing system to said first recipient, said first copy of said email comprising said file link and said ID.

The present invention advantageously provides a simple method and associated system capable of minimizing storage space for files.

### BRIEF DESCRIPTION OF THE DRAWINGS

FIG. 1 illustrates a system for removing attached files from emails before transmitting the emails to recipients, in accordance with embodiments of the present invention.

FIG. 2 illustrates an internal table of files, in accordance with embodiments of the present invention.

FIG. 3 illustrates an email ID table of files, in accordance with embodiments of the present invention.

FIG. 4 illustrates a flowchart describing an algorithm used by the system of FIG. 1 for retrieving file attachments from emails and generating links to the file attachments, in accordance with embodiments of the present invention.

FIG. 5 illustrates a flowchart describing an algorithm used by the system of FIG. 1 for deleting emails, in accordance with embodiments of the present invention

FIG. 6 illustrates a flowchart describing an algorithm used by the system of FIG. 1 for monitoring and controlling congestion, in accordance with embodiments of the present invention.

FIG. 7 illustrates a computer apparatus used for removing attached files from emails before transmitting the emails to recipients, in accordance with embodiments of the present invention.

### DETAILED DESCRIPTION OF THE INVENTION

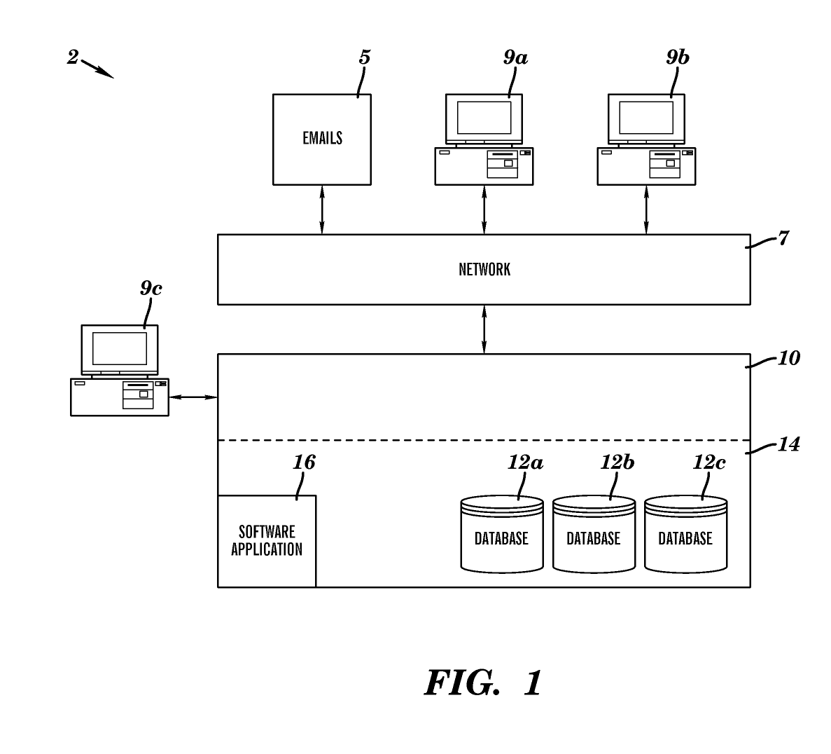

FIG. 1 illustrates a system 2 for removing attached files from emails 5 before transmitting emails 5 to recipients, in accordance with embodiments of the present invention. System 2 may allows for the following functionality associated with removing attached files (or file attachments) from emails 5:

1. File attachments are not attached to emails for recipients. The file attachments are stored in a central repository (e.g., database 12).
2. Links to the file attachments are transmitted to recipients of the emails 5 (including carbon copy and blank carbon copy recipients).
3. File attachments are stored in private locations for carbon copy and blank carbon copy recipients in order to limit or control access.
4. For each recipient, 2 tables (entries) are maintained:

A. Per file attachment: a number of users for the file attachment.

B. Per user: a total number of cumulated disk space being used.

5. During each delete function, a message is automatically transmitted to decrease a number of users for the file attachment.
6. During each archive function, the file attachment is silently attached to a local archive data base.
7. A background task monitors cumulated disk space per user and in case a threshold is reached messages are automatically transmitted for cleanup functions (e.g., archive functions, delete functions, etc).

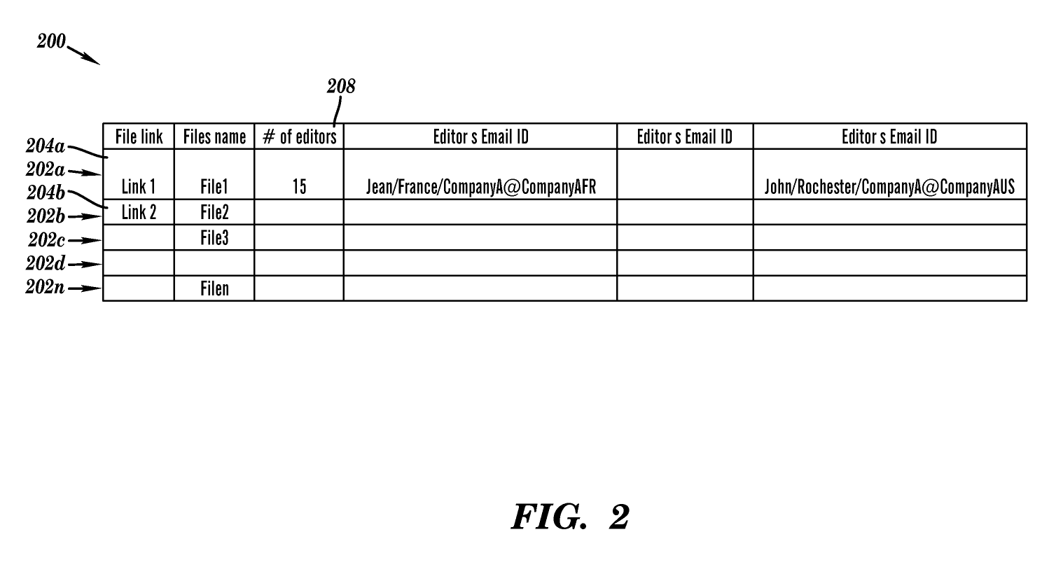

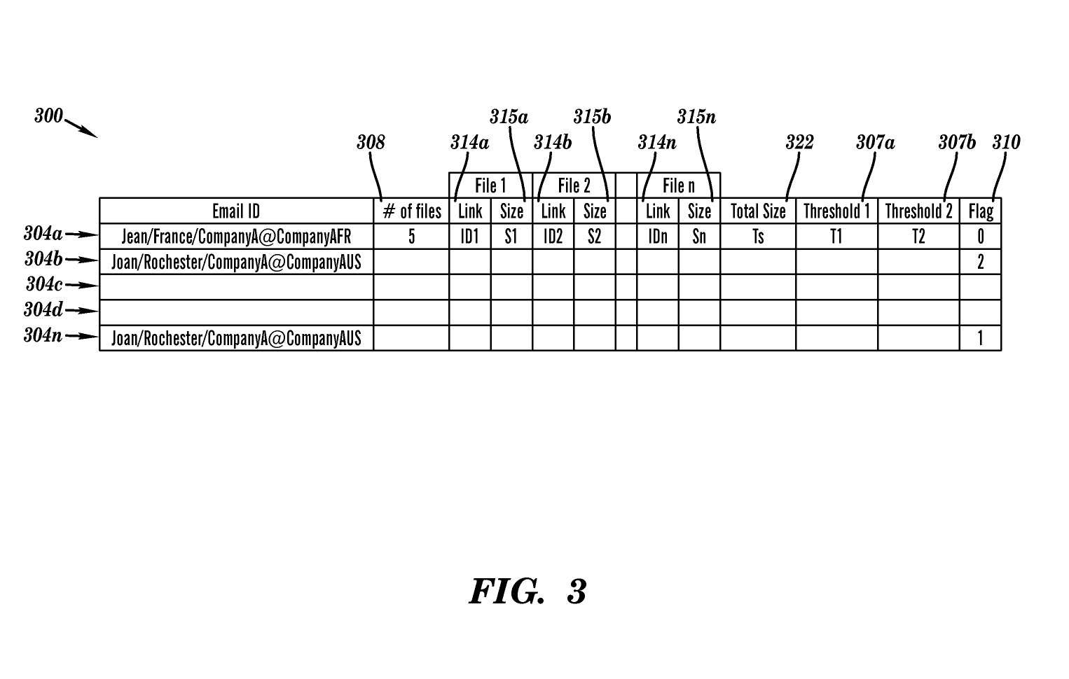

System 2 of FIG. 1 comprises a computing apparatus 9a, a computing apparatus 9b, and emails 5 connected to a computing system 10 through a network 7. Emails 5 may comprise any type of emails with attached files. Computing apparatus 9a and computing apparatus 9b are used by recipients for receiving emails 5 and retrieving file attachments for the emails 5 (i.e., from database 12c). Network 7 may comprise any type of network including, inter alia, a local area network, (LAN), a wide area network (WAN), the Internet, etc. Network 7 may comprise a wireless network. Computing system 10 may comprise any type of computing system(s) including, inter alia, a personal computer (PC), a server computer, a database computer, etc. Computing system 10 may comprise a single computing system or a plurality of computing systems. Computing system 10 comprises a memory system 14 (e.g., a database). Memory system 14 may comprise a single memory system. Alternatively, memory system 14 may comprise a plurality of memory systems. Memory system 14 may be internal to computing system (e.g., as illustrated in FIG. 1) or external to computing system 10. Memory system 14 comprises a software application 16 and databases 12 . . . 12c. System 2 may comprise an optional computing apparatus 9c connected to computing system 10. Computing apparatus 9c may be used by an administrator for entering data in databases 12a and 12b. Database 12a comprises threshold data associated with file size thresholds. Database 12b comprise tables (e.g., as described with reference to FIGS. 2 and 3) associated with file attachments (i.e., removed from emails 5) and recipients. Database 12c comprises the file attachments removed from emails 5. The file attachments may comprise any type of file attachments including, inter alia, word processing files, PDF files audio files video files, picture files, compressed files, etc. Computing apparatus 9a . . . 9c may comprise any type of computing system(s) including, inter alia, a personal computer (PC), a server computer, a database computer, a computer terminal, a notebook computer, etc.

The following process steps illustrate executing software application 16 for removing file attachments from an email (e.g., from emails 5) and attaching a link to a copy of the email before transmitting the copy to recipients:

1. Computing system 10 receives an email (from emails 5) addressed to recipients (main recipient and carbon copy recipients).
2. Computing system 10 determines that the email comprises an attached file(s).
3. Computing system 10 removes and stores the attached file(s) in database 12c.
4. Computing system 10 generates a link(s) to the attached file(s) and stores the link(s) and IDs for the attached file(s) in an internal table of files (i.e., stored in database 12b). The file link(s) point to a location(s) in database 12c for the attached file(s).
5. Computing system 10 retrieves from the internal table of files, the file link(s) and IDs associated with said attached file(s).
6. Computing system 10 generates copies (i.e., for each recipient) of the email.
7. Computing system 10 placing the file link(s) and ID(s) in each copy of the email.
8. Computing system 10 retrieves identification data associated with the recipients from the email.
9. Computing system 10 stores the identification data in a table of recipients (i.e., from database 12b.
10. Computing system 10 determines a number of users for the attached file(s).
11. Computing system 10 a file size(s) for the attached file(s).
12. Computing system 10 determines total sizes for all files being accessed by the recipients. Determining the total sizes comprises adding the file size(s) to all additional file sizes for additional files being accessed by the recipients.
13. Computing system 10 determines if the total sizes exceed a first file size threshold.
A. If the total sizes exceed a first file size threshold, a message or instructions for archiving or deleting files may be generated and transmitted to the recipients.
B. Additionally, if the total sizes exceed a first file size threshold computing system 10 may determine if the total sizes exceed a second file size threshold and another message of instructions for archiving or deleting additional files may be generated and transmitted to the recipients.
   14. Computing system 10 transmits the copies of the emails comprising the file link(s) and ID(s) to the recipients so that they may retrieve the attached files when necessary.

FIG. 2 illustrates an internal table of files 200, in accordance with embodiments of the present invention. Internal table of files 200 is used for storing links 204a and 204b for linking to file attachments (or attached files) removed from emails 5 (i.e., of FIG. 1). Internal table of files 200 may be stored in database 12b of FIG. 1. The following list describes features associated with internal table of files 200:

1. Entries 202a . . . 202n in internal table of files 200 are:

A. Created when a file attachment is placed in a database.

B. Deleted when a number of editors 208 is equal to 0.

2. A number of editors 208 in internal table of files 200 is initialized to a number of email IDs (i.e., for email recipients) in destination and in the copy lists of the email where the file is attached
3. A number of editors 208 in internal table of files 200 are updated when:

A. A forward (i.e., for the email) operation is performed for the attached file. A number of editors 208 is increased by a number of new email IDs (i.e., for email recipients) in the destination and copy lists (i.e., in order to account for possible redundant email IDs).

B. When a delete or archive operation is performed for the attached file. A number of editors 208 is decreased by a number of email IDs (i.e., for email recipients) performing a delete or archive operation.

FIG. 3 illustrates an email ID table of files 300, in accordance with embodiments of the present invention. Email ID table of files 300 (i.e., an internal table of email recipients) is used for storing mail IDs 304 a . . . 304n (i.e., for email recipients), thresholds 307a and 307b, and flag settings 310. Email ID table of files 300 may be stored in database 12b of FIG. 1. The following list describes features associated with email ID table of files 300:

1. Entries 304a . . . 304n in email ID table of files 300 are:

A. Created when a file attachment is placed in a database.

B. Deleted when a number of files 308 is equal to 0.

2. A number of files 308 in email ID table of files 300 are:
A. Initialized to a number of files in the email comprising email Ids 304 a . . . 304n in destination and copy lists.
B. Increased when new files are placed in a database for a considered email ID.
C. Decreased when an archive or a delete operation is performed by an email ID.
   3. Two fields exist for each file attachment: A link 314a . . . 314n to a file and a size 315a . . . 315n of a file. A link 314a . . . 314n to a file and a size 315a . . . 315n of the file are used to provide a user with a view of the top 10 files that are most disk consuming.
   4. A total Size 322 is a sum of the size of all files attached to an email ID. Total size 322 is used by a congestion mechanism attached to each of email IDs 304a . . . 304n.
   5. A warning threshold 307a and a critical threshold 307b are used by the congestion mechanism attached to each of email IDs 304a . . . 304n so that:

A. When warning threshold 307 is reached a message will be sent to an associated email ID with a list of the top 10 consuming files in order to delete or archive the files.

B. When a critical threshold is reached a message will be sent to an associated email ID in order to block its email.

6. A congestion flag 310 is set to the following settings as described:

A. 0 when a mean total size is less than all thresholds.

B. 1 when a mean total size is between a warning level and a critical level.

C. 2 when a mean total size is greater than a critical level.

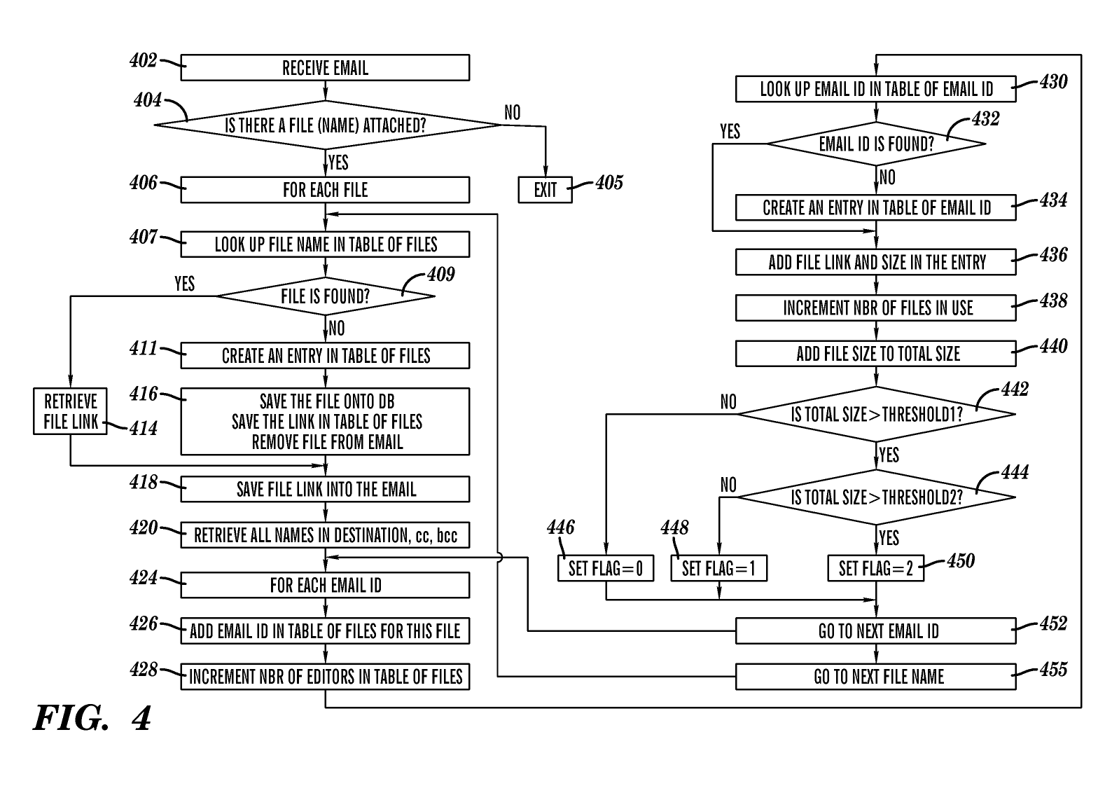

FIG. 4 illustrates a flowchart describing an algorithm used by system 2 of FIG. 1 for retrieving file attachments from emails and generating links to the file attachments, in accordance with embodiments of the present invention. In step 402, a computing system (e.g., computing system 10 of FIG. 1) receives an email. In step 404, (i.e., for each mail received by the computing system), a check is performed to look for a file attachment (e.g., either a full file or a file name). If in step 404, it is determined that there is no file attachment located then the process terminates in step 405. If in step 404, it is determined that there is a file attachment located then in step 406, a loop of processing is initiated for each file attachment located in the email. In step 407, a lookup function is performed in a table of files to retrieve information associated with the file. In step 409, it is determined if an entry for a file is located in the table of files. If in step 409, it is determined that an entry for the file exists in the table of files then in step 414, a link pointing to this file saved on the computing system is retrieved from parameters of the entry in the table of files. If in step 409, it is determined that an entry for the file does not exists in the table of files then in step 411 an empty record is created in the table of files. In step 416 the file is saved on an email server disk and the link pointing to this file saved on the server is saved in the newly created record in the table of files. The file is removed from the original email. In step 418, a file name and link (i.e., for the file) are saved on the email (or copies of the email). In step 420, all recipient names in destination, copy, and blind copy fields are retrieved from the email. In step 424, a loop of processing is initiated for all recipient names located. All names located are referred herein to email-id. In step 426, each email-id is saved in a record entry of the table of files. In step 428, a number of editor parameters are incremented by one. This process will generate a current number of users accessing the file. In step 420, a look up operation is performed in order to locate a current email id in the table of email-ids. In step 432, it is determined if a current email id is located. If in step 432 it is determined that a current email id is not located then in step 434 a new entry is created in the table of email ids for this person and step 436 is executed as described, infra. If in step 432 it is determined that a current email id is located then in step 436, the file link and a file size are saved in the entry in the table of email ids for this user. In step 117, a number of files in use for this user are incremented by one. This process will always give a current number of files in use for each user. In step 440, a total size number for this user is incremented by a size of the current file. This process will always will always give a current total size in use for each user. In step 442, the total size from step 440 is compared to a threshold 1 (warning level). If in step 442, the total size from step 440 is less than threshold 1 then in step 446, the congestion flag is set to 0 (i.e., the congestion flag is reset). If in step 442, the total size from step 440 is greater than threshold 1 then in step 444, the total size from step 440 is compared to a threshold 2 (critical level). If in step 444, the total size from step 440 is less than threshold 2 then in step 448, the congestion flag is set to 1. If in step 444, the total size from step 440 is greater than threshold 2 then in step 450, the congestion flag is set to 2. Step 452, directs the algorithm to repeat steps 426-450 for a next recipient. Step 455, directs the algorithm to repeat steps 407-452 for a next file attached.

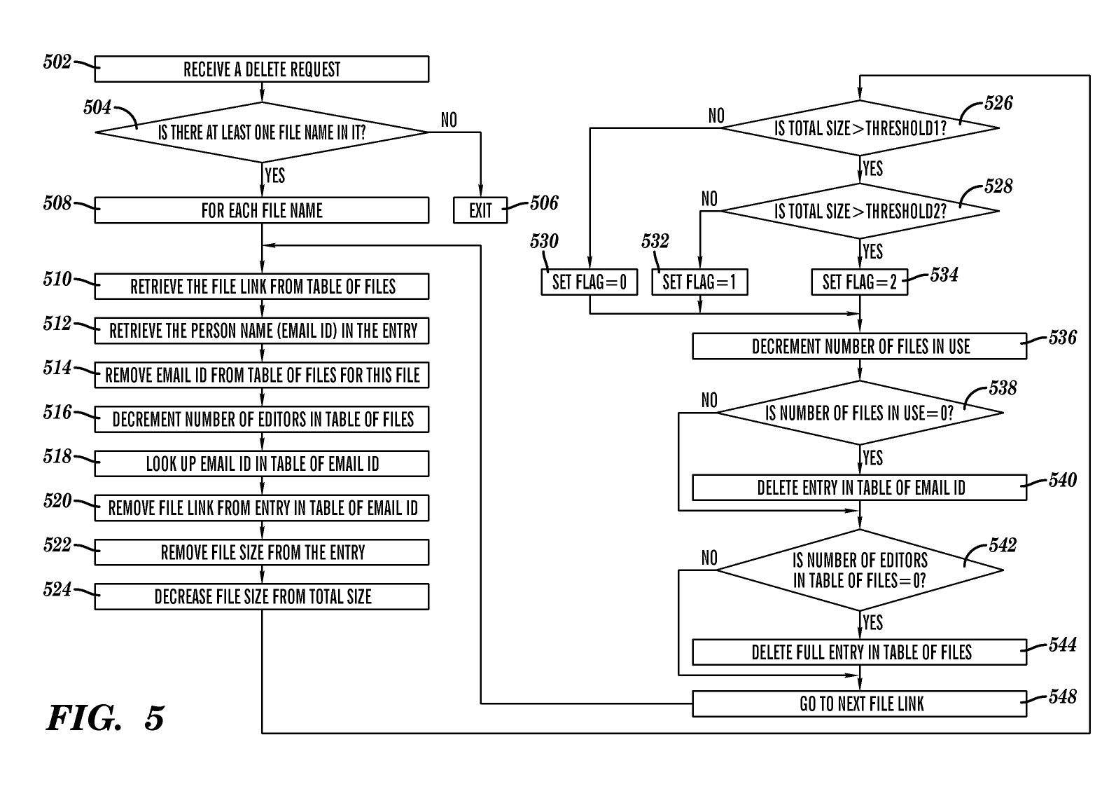

FIG. 5 illustrates a flowchart describing an algorithm used by system 2 of FIG. 1 for deleting emails, in accordance with embodiments of the present invention. In step 502, a computing system (e.g., computing system 10 of FIG. 1) receives a request for deleting an email associated with a recipient. In step 504, a check function is performed to locate for a file name in the email to be deleted (i.e., receiving the request in step 502). If in step 504, it is determined that there is not a file name located in the email then the process terminates in step 506. If in step 504, it is determined that there is a file name located in the email then in step 508, a loop of processing is initiated for each file name located in the email. In step 510, a lookup in a table of files is performed in order to retrieve a file link and corresponding record. In step 512, an email ID of the recipient (i.e., deleting the name) is retrieved from the corresponding record. In step 514, the note ID is cleared in the record of the table of files. In step 516, a number of editor parameters are decremented by one thereby producing a current number of persons having the file in use. In step 518, a look up operation is performed for the current email-ID in the table of all email-IDs. In step 520, the file link is removed from the record found in the table of email-IDs. In step 522, a file size is removed from the record found in the table of email-IDs. In step 524, a total size number for the recipient is decremented by the size of the current file thereby producing a current total size in use for the recipient. In step 526, the total size from step 524 is compared to a threshold 1 (warning level). If in step 526, the total size from step 524 is less than the threshold 1 then in step 530, the congestion flag is set to 0 (i.e., the congestion flag is reset). If in step 526, the total size from step 524 is greater than threshold 1 then in step 528, the total size from step 524 is compared to a threshold 2 (critical level). If in step 528, the total size from step 524 is less than threshold 2 then in step 532, the congestion flag is set to 1. If in step 528, the total size from step 524 is greater than threshold 2 then in step 534, the congestion flag is set to 2. In step 536, a number of files in use for the recipient are decremented by one thereby generating a current number of files in use for each user. In step 538, a check operation is performed to determine the number of files in use. If in step 538, it is determined that the number of files in use is equal to zero then in step 540, the record for the recipient is deleted from the table of email IDs and step 542 is executed as described, infra. If in step 538, it is determined that the number of files in use is not equal to zero then in step 542, a check operation is performed to determine a number of editors in the table of files. If in step 542, it is determined that the number of editors in use is equal to zero then in step 544, the record for the file is deleted from the table of files and step 548 is executed as described, infra. If in step 542, it is determined that the number of editors in use is not equal to zero then in step 548 steps 510-544 are repeated for a next file name.

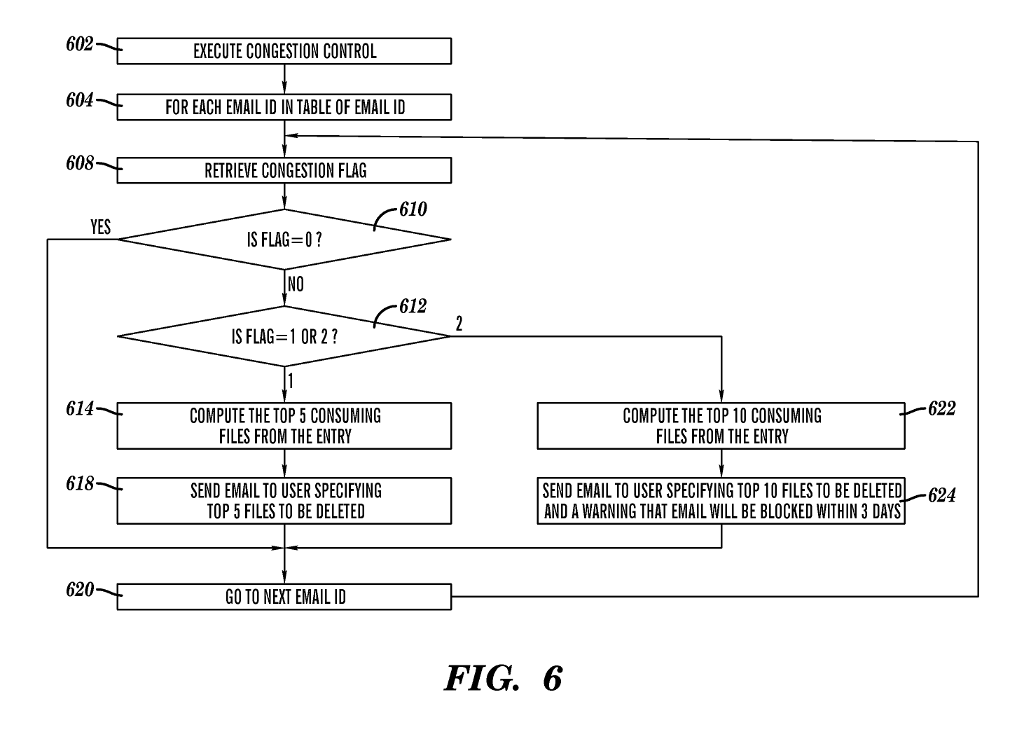

FIG. 6 illustrates a flowchart describing an algorithm used by system 2 of FIG. 1 for monitoring and controlling congestion, in accordance with embodiments of the present invention. In step 602, a task is triggered to monitor congestion for each recipient. In step 604, a loop of processing is initiated for all recipients (i.e., email IDs) in the table of email IDs. In step 608, a congestion flag for a recipient is retrieved from the record. In step 610, it is determined if the congestion flag is equal to zero. If in step 610, it is determined that the congestion flag is equal to zero then step 620 is executed as described, infra. If in step 610, it is determined that the congestion flag is not equal to zero then in step 612, it is determined if the congestion flag is equal to 1 or 2.

If in step 612, it is determined that the congestion flag is equal to 2 then in step 622, the biggest files (based on each file size stored in the record) associated with the recipient are retrieved from the entry. In step 624, an email is transmitted to the recipient with the list of the biggest files names so that the recipient may execute actions to delete the emails with these 10 files attached if they are no longer valid and step 620 is executed as described, infra. Additionally, a warning in the email about the mailbox of the recipient being locked out in the next 3 days could be added.

If in step 612, it is determined that the congestion flag is equal to 1 then in step 614, the 5 biggest files (based on each file size stored in the record) associated with the recipient are retrieved from the entry. In step 618, an email is transmitted to the recipient with the list of the 5 biggest files names so that the recipient may execute actions to delete the emails with these 5 files attached if they are no longer valid. Step 620 executes steps 608-624 for a next recipient in the table.

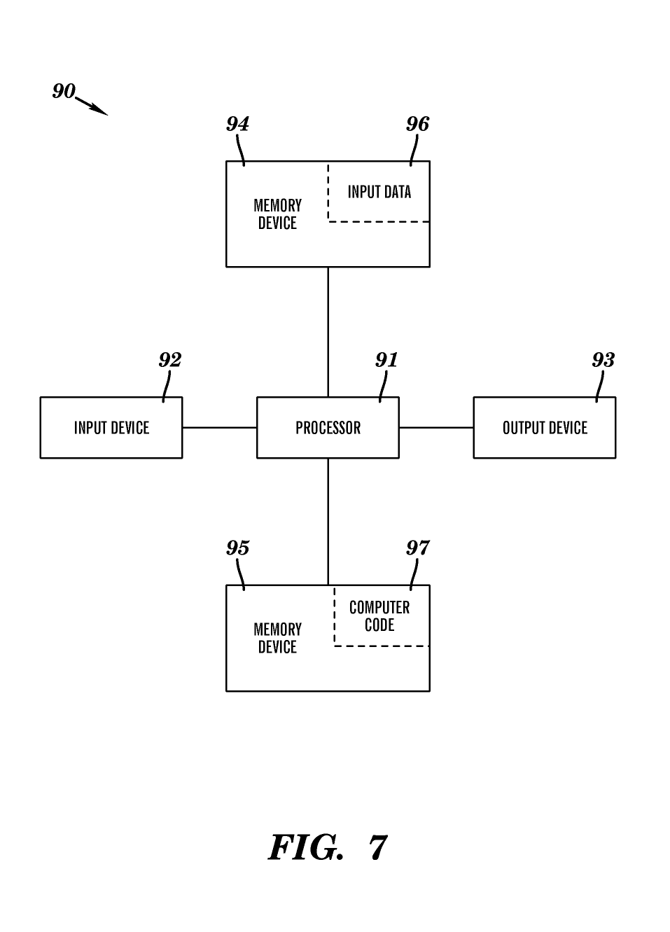

FIG. 7 illustrates a computer apparatus 90 (e.g., computing system 10 of FIG. 1) used for removing attached files from emails before transmitting the emails to recipients, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 4-6) for removing attached files from emails before transmitting the emails to recipients. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 7) may comprise the algorithms of FIGS. 4-6 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be created, integrated, hosted, maintained, deployed, managed, serviced, etc. by a service provider who offers to remove attached files from emails before transmitting the emails to recipients. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for removing attached files from emails before transmitting the emails to recipients. In another embodiment, the invention provides a business method that performs the process steps of the invention on a subscription, advertising, and/or fee basis. That is, a service provider, such as a Solution Integrator, could offer to perform a process for removing attached files from emails before transmitting the emails to recipients. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
receiving, by a computing system, an email addressed to a first recipient, wherein said first recipient is a main recipient for said email;
determining, by said computing system, that said email comprises an attached file;
retrieving, by said computing system from an internal table of files, a file link and an ID associated with said attached file, wherein said file link points to a location within said computing system for said attached file;
removing, by said computing system, said attached file from said email;
after said removing, generating by said computing system, a first copy of said email;
placing, by said computing system in said first copy of said email, said file link and said ID;
retrieving, by said computing system from said email, first identification data associated with said first recipient;
storing, by said computing system in a first portion of an internal table of recipients, said first identification data, wherein said first portion of said internal table of recipients is reserved for said first recipient;
determining, by said computing system, a number of users for said attached file;
storing, by said computing system in said internal table of files, said first link and a file size for said attached file;
determining, by said computing system, a first total size for all files being accessed by said first recipient, wherein said determining said first total size comprises adding said file size to all additional file sizes for additional files being accessed by said first recipient;
determining, by said computing system, if said first total size exceeds a first file size threshold; and
transmitting, by said computing system to said first recipient, said first copy of said email comprising said file link and said ID.

2. The method of claim 1, wherein said email is addressed to a second recipient, wherein said second recipient is a carbon copy recipient for said email, and wherein said method further comprises:
after said removing, generating by said computing system, a second copy of said email;
placing, by said computing system in said second copy of said email, said file link, and said ID;
retrieving, by said computing system from said email, second identification data associated with said second recipient;
storing, by said computing system in a second portion of said internal table of recipients, said second identification data, wherein said second portion of said internal table of recipients is reserved for said second recipient;
determining, by said computing system, a second total size for all files being accessed by said second recipient, wherein said determining said second total size comprises adding said file size to all additional file sizes for additional files being accessed by said second recipient;
determining, by said computing system, if said second total size exceeds said first file size threshold; and
transmitting, by said computing system to said second recipient, said second copy of said email comprising said file link and said ID.

3. The method of claim 2, wherein said determining if said first total size exceeds said first file size threshold determines that said first total size exceeds said first file size threshold, and wherein said method further comprises;
determining, by said computing system, that said first total size exceeds a second file size threshold;
setting, by said computing system, a first congestion flag associated with said first recipient to a first specified setting;
monitoring, by said computing system, said first congestion flag;
determining, by said computing system based on said monitoring said first congestion flag, that said first congestion flag is set to said first specified setting;
generating, by said computing system, a first message indicating instructions for removing specified files of said additional files being accessed by said first recipient from said computing system; and
transmitting, by said computing system, said first message to said first recipient.

4. The method of claim 3, wherein said determining if said second total size exceeds said first file size threshold determines that said first total size exceeds said first file size threshold, and wherein said method further comprises;
determining, by said computing system, that said second total size exceeds said second file size threshold;
setting, by said computing system, a second congestion flag associated with said second recipient to said first specified setting;
monitoring, by said computing system, said second congestion flag;
determining, by said computing system based on said monitoring said second congestion flag, that said second congestion flag is set to said first specified setting;
generating, by said computing system, a second message indicating instructions for removing specified files of said additional files being accessed by said second recipient from said computing system; and
transmitting, by said computing system, said second message to said second recipient.

5. The method of claim 2, wherein said carbon copy recipient is a blind carbon copy recipient.

6. The method of claim 2, further comprising:
before said retrieving said file link and said ID, generating by said computing system, an entry position in said internal table of files;
storing, by said computing system, said attached file;
generating, by said computing system, said file link; and
storing, by said computing system in said entry position, said file link and said ID.

7. The method of claim 1, further comprising:
before said storing said first identification data, generating by said computing system, an entry position in said internal table of recipients.

8. The method of claim 1, wherein said determining if said first total size exceeds a first file size threshold determines that said first total size exceeds said first file size threshold, and wherein said method further comprises;
generating, by said computing system, a warning message indicating that said first total size exceeds said first file size threshold; and
transmitting, by said computing system, said warning message to said first recipient.

9. The method of claim 8, further comprising:
determining, by said computing system, that said first total size exceeds a second file size threshold;
generating, by said computing system, instructions for decreasing said first total size; and
transmitting, by said computing system, said instructions to said first recipient.

10. The method of claim 9, further comprising:
receiving, by said computing system from said first recipient in response to said instructions, a command for removing said email and said attached file from said computing system;
removing, by said computing system from said internal table of files, said file link, said ID, said first identification data, and said file size;
determining, by said computing system, a second total size for all files being accessed by said first recipient, wherein said determining said second total size comprises removing said file size from all additional file sizes for all additional files being accessed by said first recipient;
determining, by said computing system, if said second total size exceeds said first file size threshold; and
removing, by said computing system, said email.

11. A computer program product, comprising a computer storage medium comprising a computer readable program code embodied therein, said computer readable program code configured to perform the method of claim 1 upon being executed by a processor of said computing system.

12. A computing system comprising a processor coupled to a computer-readable memory unit, said memory unit comprising instructions that when executed by the processor implements an email method, said method comprising:
receiving, by a computing system, an email addressed to a first recipient, wherein said first recipient is a main recipient for said email;
determining, by said computing system, that said email comprises an attached file;
retrieving, by said computing system from an internal table of files, a file link and an ID associated with said attached file, wherein said file link points to a location within said computing system for said attached file;
removing, by said computing system, said attached file from said email;
after said removing, generating by said computing system, a first copy of said email;
placing, by said computing system in said first copy of said email, said file link and said ID;
retrieving, by said computing system from said email, first identification data associated with said first recipient;
storing, by said computing system in a first portion of an internal table of recipients, said first identification data, wherein said first portion of said internal table of recipients is reserved for said first recipient;
determining, by said computing system, a number of users for said attached file;
storing, by said computing system in said internal table of files, said first link and a file size for said attached file;
determining, by said computing system, a first total size for all files being accessed by said first recipient, wherein said determining said first total size comprises adding said file size to all additional file sizes for additional files being accessed by said first recipient;
determining, by said computing system, if said first total size exceeds a first file size threshold; and
transmitting, by said computing system to said first recipient, said first copy of said email comprising said file link and said ID.

13. The computing system of claim 12, wherein said email is addressed to a second recipient, wherein said second recipient is a carbon copy recipient for said email, and wherein said method further comprises:
after said removing, generating by said computing system, a second copy of said email;
placing, by said computing system in said second copy of said email, said file link, and said ID;
retrieving, by said computing system from said email, second identification data associated with said second recipient;
storing, by said computing system in a second portion of said internal table of recipients, said second identification data, wherein said second portion of said internal table of recipients is reserved for said second recipient;
determining, by said computing system, a second total size for all files being accessed by said second recipient, wherein said determining said second total size comprises adding said file size to all additional file sizes for additional files being accessed by said second recipient;
determining, by said computing system, if said second total size exceeds said first file size threshold; and
transmitting, by said computing system to said second recipient, said second copy of said email comprising said file link and said ID.

14. The computing system of claim 13, wherein said determining if said first total size exceeds said first file size threshold determines that said first total size exceeds said first file size threshold, and wherein said method further comprises:
determining, by said computing system, that said first total size exceeds a second file size threshold;
setting, by said computing system, a first congestion flag associated with said first recipient to a first specified setting;
monitoring, by said computing system, said first congestion flag;
determining, by said computing system based on said monitoring said first congestion flag, that said first congestion flag is set to said first specified setting;
generating, by said computing system, a first message indicating instructions for removing specified files of said additional files being accessed by said first recipient from said computing system; and
transmitting, by said computing system, said first message to said first recipient.

15. The computing system of claim 14, wherein said determining if said second total size exceeds said first file size threshold determines that said first total size exceeds said first file size threshold, and wherein said method further comprises:
determining, by said computing system, that said second total size exceeds said second file size threshold;
setting, by said computing system, a second congestion flag associated with said second recipient to said first specified setting;
monitoring, by said computing system, said second congestion flag;
determining, by said computing system based on said monitoring said second congestion flag, that said second congestion flag is set to said first specified setting;
generating, by said computing system, a second message indicating instructions for removing specified files of said additional files being accessed by said second recipient from said computing system; and
transmitting, by said computing system, said second message to said second recipient.

16. The computing system of claim 13, wherein said method further comprises:
before said retrieving said file link and said ID, generating by said computing system, an entry position in said internal table of files;
storing, by said computing system, said attached file;
generating, by said computing system, said file link; and
storing, by said computing system in said entry position, said file link and said ID.

17. The computing system of claim 12, wherein said method further comprises:
before said storing said first identification data, generating by said computing system, an entry position in said internal table of recipients.

18. The computing system of claim 12, wherein said determining if said first total size exceeds a first file size threshold determines that said first total size exceeds said first file size threshold, and wherein said method further comprises;
generating, by said computing system, a warning message indicating that said first total size exceeds said first file size threshold; and
transmitting, by said computing system, said warning message to said first recipient.

19. The computing system of claim 12, wherein said method further comprises:
determining, by said computing system, that said first total size exceeds a second file size threshold;
generating, by said computing system, instructions for decreasing said first total size; and
transmitting, by said computing system, said instructions to said first recipient.

20. The computing system of claim 19, wherein said method further comprises:
receiving, by said computing system from said first recipient in response to said instructions, a command for removing said email and said attached file from said computing system;
removing, by said computing system from said internal table of files, said file link, said ID, said first identification data, and said file size;
determining, by said computing system, a second total size for all files being accessed by said first recipient, wherein said determining said second total size comprises removing said file size from all additional file sizes for all additional files being accessed by said first recipient;
determining, by said computing system, if said second total size exceeds said first file size threshold; and
removing, by said computing system, said email.
